(19) United States
(12) Patent Application Publication
(10) Pub. No.: US 2025/0227507 A1
(43) Pub. Date: Jul. 10, 2025

(54) AI MODEL PROCESSING METHOD AND APPARATUS, AND COMMUNICATION DEVICE

(71) Applicant: VIVO MOBILE COMMUNICATION CO., LTD., Guangdong (CN)

(72) Inventor: Ang Yang, Guangdong (CN)

(73) Assignee: VIVO MOBILE COMMUNICATION CO., LTD., Guangdong (CN)

(21) Appl. No.: 19/090,640

(22) Filed: Mar. 26, 2025

Related U.S. Application Data
(63) Continuation of application No. PCT/CN2023/119939, filed on Sep. 20, 2023.

(30) Foreign Application Priority Data
Sep. 26, 2022 (CN) 202211177514.5

(51) Int. Cl. H04W 24/02; H04L 41/16; H04W 84/04

(52) U.S. Cl. CPC H04W 24/02; H04L 41/16; H04W 84/042

(57) ABSTRACT

This application discloses an AI model processing method and apparatus, and a communication device. The method includes: obtaining, by a terminal, at least one piece of AI model information, the AI model information carrying or being associated with a model identity of an AI model, where the model identity indicates, or includes, or is associated with first information; in a case that the environment or working status or operating parameter associated with the first information changes, activating, or switching, or updating, by the terminal, to obtain a target AI model; or, in a case that the terminal identifies the model identity of the target AI model, activating, or switching, or updating, by the terminal, to obtain the target AI model, where the model identity of the target AI model indicates, or includes, or is associated with the identity information of the terminal.

### CROSS-REFERENCE TO RELATED APPLICATIONS

This application is a continuation application of PCT International Application No. PCT/CN2023/119939 filed on Sep. 20, 2023, which claims priority to Chinese Patent Application No. 202211177514.5, filed on Sep. 26, 2022, which is incorporated herein by reference in its entirety.

### TECHNICAL FIELD

This application belongs to the field of communication, and in particular to an artificial intelligence (AI) model processing method and apparatus, and a communication device.

### BACKGROUND

At present, AI is widely applied in various fields. There are various implementation modes for AI models, such as a neural network, a decision-making tree, a support vector machine, and a Bayesian classifier.

In the related art, the AI model is updated by being transmitted, and then this update mode has a large network signaling overhead.

### SUMMARY

Embodiments of this application provide an AI model processing method and apparatus, and a communication device.

According to a first aspect, an AI model processing method is provided, including:
obtaining, by a terminal, at least one piece of AI model information, the AI model information carrying or being associated with a model identity of an AI model, where the model identity indicates, or includes, or is associated with first information, and the first information is used for representing information related to an environment or working status or operating parameter of the terminal;
in a case that the environment or working status or operating parameter associated with the first information changes, activating, or switching, or updating, by the terminal, to obtain a target AI model, where a model identity of the target AI model indicates, or includes, or is associated with first information related to a new environment or working status or operating parameter;
or, in a case that the terminal identifies the model identity of the target AI model, activating, or switching, or updating, by the terminal, to obtain the target AI model, where the model identity of the target AI model indicates, or includes, or is associated with the identity information of the terminal.

According to a second aspect, an AI model processing apparatus is provided, including:
an obtaining module, configured to obtain at least one piece of AI model information, the AI model information carrying or being associated with a model identity of an AI model, where the model identity indicates, or includes, or is associated with first information, and the first information is used for representing information related to an environment in which a terminal is located or a working status of the terminal or an operating parameter of the terminal;
a first processing module, configured to: in a case that the environment or working status or operating parameter associated with the first information changes, activate, or switch, or update a target AI model, where the model identity of the target AI model indicates, or includes, or is associated with first information related to a new environment or working status or operating parameter;
or, a second processing module, configured to: in a case that the terminal identifies the model identity of the target AI model, activate, or switch, or update the target AI model, where the model identity of the target AI model indicates, or includes, or is associated with the identity information of the terminal.

According to a third aspect, a communication device is provided, including: a processor, a memory, and a program or instruction stored in the memory and runnable on the processor, where the program or instruction, when executed by the processor, implements steps of the method according to the first aspect.

According to a fourth aspect, a readable storage medium is provided. The readable storage medium stores a program or instruction, where the program or instruction, when executed by the processor, implements steps of the method according to the first aspect.

According to a fifth aspect, a chip is provided. The chip includes a processor and a communication interface. The communication interface is coupled to the processor. The processor is configured to run a program or instruction to implement steps of the method according to the first aspect.

According to a sixth aspect, a computer program/program product is provided. The computer program/program product is stored in a non-transient storage medium, and the computer program/program product is executed by at least one processor to implement steps of the method according to the first aspect.

According to a seventh aspect, a communication system is provided, including: a terminal and a network side device, where the terminal is configured to execute steps of the method according to the first aspect.

### BRIEF DESCRIPTION OF THE DRAWINGS

FIG. 1 is a schematic diagram of a neural network;

FIG. 2 is a schematic diagram of a neuron;

FIG. 3 is a schematic architectural diagram of a wireless communication system according to an embodiment of this application;

FIG. 4 is a flowchart of an AI model processing method according to an embodiment of this application;

FIG. 5 is a schematic diagram of an AI model processing apparatus according to an embodiment of this application;

FIG. 6 is a schematic diagram of a terminal according to an embodiment of this application; and

FIG. 7 is a schematic diagram of a communication device according to an embodiment of this application.

### DETAILED DESCRIPTION

Technical solutions in embodiments of this application are clearly described in the following with reference to accompanying drawings in the embodiments of this application. Apparently, the described embodiments are merely some rather than all the embodiments of this application. Based on the embodiments of this application, all other embodiments derived by persons of ordinary skill in the art should fall within the protection scope of this application.

In the specification and claims of this application, the terms such as “first” and “second” are intended to distinguish between similar environments, or working statuses, or operating parameters, but are not used to describe a specific order or sequence. It should be understood that the terms used in this way may be interchanged under appropriate circumstances, such that the embodiments of this application may be implemented in a sequence other than those illustrated or described herein. Moreover, the environments, or the working statuses, or the operating parameters distinguished by “first” and “second” are usually of the same category and the number of the environments, or the working statuses, or the operating parameters is not limited. For example, there may be one or more first working environments, or working statuses, or operating parameters. In addition, “and/or” in this specification and the claims represents at least one of the connected environment or working status or operating parameter, and a character “/” used herein generally represents that the environment or working status or operating parameter associated front and behind is an “or” relationship.

It is worth pointing out that the technology described in the embodiment of this application is not limited to a long term evolution (LTE)/LTE-advanced (LTE-A) system, and can also be used in other radio communication systems, such as code division multiple access (CDMA), time division multiple access (TDMA), frequency division multiple access (FDMA), orthogonal frequency division multiple access (OFDMA), single-carrier frequency division multiple access (SC-FDMA) and other systems. The terms “system” and “network” in the embodiments of this application are often used interchangeably, and the described technology can be applied to the systems and radio technologies mentioned above, and can be also applied to other systems and radio technologies. The following describes a new radio (NR) system for the example purpose and uses the term NR in most of the following descriptions. However, these technologies can alternatively be applied to applications except the NR system application, such as a 6th generation (6G) communication system.

For the convenience of understanding the embodiments of this application, the following technical points will be introduced first.

### 1. Introduction to the Neural Network

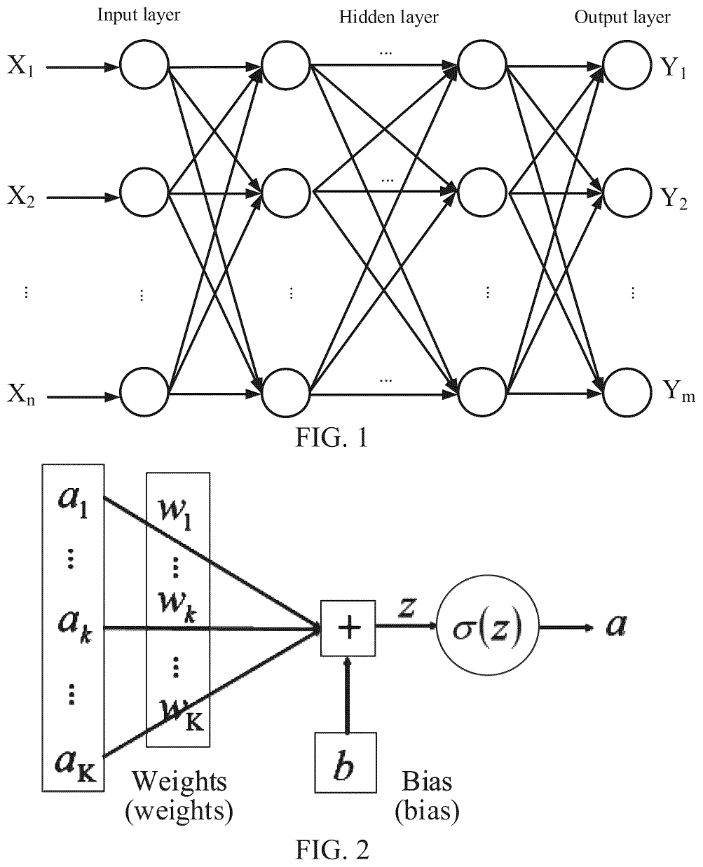

This application is illustrated taking the neural network as an example, rather than limiting a specific type of the AI module. The structure of the neural network is shown in FIG. 1.

The neural network includes neurons, and a schematic diagram of the neurons is shown in FIG. 2. a₁, a₂, . . . a_{K} are inputs, w is a weight (a multiplicative coefficient), b is a bias (an additive coefficient), σ(⋅) is an activation function, and z=a₁w₁+ . . . +aₖwₖ+ . . . +a_{K}w_{K}+b. Common activation functions include an Sigmoid function, a tanh function, a rectified linear unit (ReLU), and the like.

Parameters of the neural network may be optimized by using an optimization algorithm. The optimization algorithm is a type of algorithms that can help minimize or maximize an objective function (sometimes referred to as a loss function). The objective function is usually a mathematical combination of a model parameter and data. For example, data x and a label Y corresponding to the data x are given, and a neural network model f(⋅) is constructed. With this model, a predicted output f(x) may be obtained based on an input x, and a gap (f(x)−Y) between a predicted value and a real value may be calculated. This is a loss function. If appropriate w and b are found, to make a value of the loss function reach a minimum, a smaller loss value indicates that the model is closer to a real situation.

Currently, common optimization algorithms are basically based on an error back propagation (BP) algorithm. A basic idea of the BP algorithm is that a learning process includes two processes: signal forward propagation and error back propagation. During forward propagation, an input sample is transmitted from an input layer, processed layer by layer by each hidden layer, and then transmitted to an output layer. If an actual output of the output layer does not match an expected output, an error back propagation stage is performed. The error back propagation is to transmit an output error in a form layer by layer back to the input layer through hidden layers, and distribute the error to all units at each layer, to obtain an error signal of the units at each layer. This error signal is used as a basis for correcting a weight of each unit. Such a weight adjustment process at each layer of signal forward propagation and error back propagation is performed cyclically. The process of continuously adjusting the weight is a learning training process of the network. This process continues until an error outputted by the network is reduced to an acceptable degree or a preset quantity of times of learning is performed.

Generally, according to different types of solutions, selected AI algorithms and used models also vary. According to the related art, a main method for improving performance of a fifth generation mobile communication technology (5G) network through AI is to enhance or replace an existing algorithm or processing module by using an algorithm and a model based on the neural network. In a specific scenario, an algorithm and a model based on a neural network can achieve better performance than a deterministic algorithm. Commonly used neural networks include a deep neural network, a convolutional neural network, a recurrent neural network, and the like. With the help of existing AI tools, neural networks can be built, trained, and verified.

Common optimization algorithms include gradient descent, stochastic gradient descent (SGD), mini-batch gradient descent, momentum, Nesterov (the name of the inventor, specifically stochastic gradient descent with momentum), adaptive gradient descent (Adagrad), adaptive learning rate adjustment (Adaptive Delta Gradient Descent, Adadelta), root mean square prop (RMSprop), adaptive moment estimation (Adam), and the like.

During error back propagation, in these optimization algorithms, an error/loss is obtained according to the loss function, a gradient is obtained by calculating a derivative/partial derivative of a current neuron, and adding an effect such as a learning rate and a previous gradient/derivative/partial derivative, and the gradient is transferred to an upper layer.

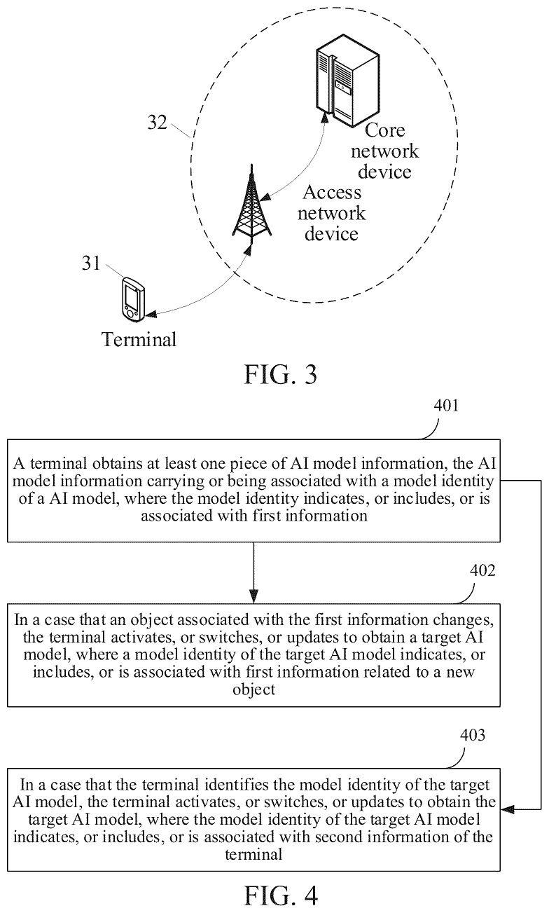

FIG. 3 is a block diagram of an applicable wireless communication system according to an embodiment of this application. The wireless communication system includes a terminal 31 and a network side device 32.

The terminal 31 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), a smart home (a home device having a wireless communication function, for example, a refrigerator, a television, a washing machine, or furniture), a game console, a personal computer (PC), a teller machine, or an automated machine. The wearable device includes: a smartwatch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. In addition to the foregoing terminal devices, the terminal involved in this application may also be a chip in a terminal, for example, a modem chip or a system on chip (SoC). It should be noted that a specific type of the terminal 31 is not limited in the embodiment of this application.

The network side device 32 may include an access network device or a core network device. The access network device may alternatively be referred to as a radio access network device, a Radio Access Network (RAN), a radio access network function, or a radio access network unit. The access network device may include a base station, a WLAN access point or a WiFi node or the like, the base station may be referred to as a node B, an evolved node B (eNB), an access point, a base transceiver station (BTS), a radio base station, a radio transceiver, a basic service set (BSS), an extended service set (ESS), a home node B, a home evolved node B, a transmitting receiving point (TRP) or some other suitable terms in the field as long as the same technical effect is achieved, and the base station is not limited to a specific technical word, it should be noted that: in the embodiment of this application, only a base station in an NR system is described as an example, and a specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), a non-3GPP inter working function (N3IWF), or the like. It should be noted that in the embodiments of this application, only the core network device in the NR system is used as an example for introduction, and the specific type of the core network device is not limited.

The AI model processing method and apparatus, a communication device, and a readable storage medium provided by the embodiments of this application will be described below through some embodiments and their application scenarios in combination with the accompanying drawings.

Referring to FIG. 4, an embodiment of this application provides an AI model processing method applied to a terminal, specifically including the following steps: step 401, step 402, or step 403, and specific steps are as follows:

Step 401: A terminal obtains at least one piece of AI model information, the AI model information carrying or being associated with a model identity (ID) of an AI model, where the model identity indicates, or includes, or is associated with first information, and the first information is used for representing information related to an environment in which the terminal is located or a working status of the terminal or an operating parameter of the terminal.

The AI model information carries the model ID of the AI model, meaning that the AI model information may include the model ID of the AI model, that is, the AI model information explicitly includes the model ID of the AI model; and the AI model information is associated with the model ID of the AI model, meaning that the AI model information and the model ID of the AI model have a mapping relationship. Upon obtaining the AI model information, the terminal may determine the model ID of the AI model based on the AI model information and the mapping relationship, that is, the AI model information implicitly includes the model ID of the AI model.

The model ID indicates the first information, meaning that the model ID is directly used for indicating the first information; the model ID includes the first information, meaning that the model ID directly includes the first information; and the model ID is associated with the first information, meaning that the model ID has a mapping relationship with the first information.

In an implementation of this application, the first information includes one or more of the following: a cell identity; an identity of a network operator; a network device provider identity; location information; channel quality information; bandwidth part (BWP) information; frequency information; public land mobile network (PLMN) information; and timestamp information.

Step 402: In a case that the environment or working status or operating parameter associated with the first information changes, the terminal activates, or switches, or updates to obtain a target AI model, where a model identity of the target AI model indicates, or includes, or is associated with first information related to a new environment or working status or operating parameter,
where the environment or working status or operating parameter may include, but is not limited to, at least one of the following: a cell, a service area of a network operator, a service area of a network device provider, a location area, a channel quality interval, a BWP, an operating frequency, a PLMN, a time interval, and the like. It may be understood that when the terminal moves, or the working status of the terminal changes, or the environment of the terminal changes, the environment or working status or operating parameter may be caused to change.

The first information related to the new environment or working status or operating parameter means that the new environment or working status or operating parameter has a mapping relationship with the first information. For example, when the new environment is a new cell, the first information related to the new environment refers to a cell identity of the new cell. For another example, when the new environment is a service area of a new network operator, the first information related to the new environment refers to an identity of the network operator of the service area of the new network operator. For another example, when the new environment is a service area of a new network device provider, the first information related to the new environment refers to a network device provider identity of the service area of the new network device provider. For another example, when the new environment is a new location area, the first information related to the new environment refers to location information of a new location area. For another example, when the new working status or the operating parameter is a new channel quality interval, the first information related to the new working status or the operating parameter refers to channel quality information of the new channel quality interval. For another example, when the new working status or the operating parameter is a new BWP, the first information related to the new working status or the operating parameter refers to BWP information of the new BWP. For another example, when the new working status or the operating parameter is a new operating frequency, the first information related to the new working status or the operating parameter refers to frequency information of the new operating frequency. For another example, when the new working status or the operating parameter is a new PLMN, the first information related to the new working status or the operating parameter is the PLMN information of the new PLMN. For another example, when the new operating parameter is a new time interval, the first information related to the new operating parameter is timestamp information of the new time interval.

Activating, by the terminal, the target AI model refers to activating, by the terminal, the target AI model that is previously in an inactive state, so that the terminal may use the target AI model; switching, by the terminal, the AI model means that the terminal is switched from the current AI model to the target AI model, so that the terminal may use the target AI model; updating, by the terminal, the target AI model refers to updating, by the terminal, the AI model to obtain the target AI model. Updating the AI model may include, but is not limited to, updating AI model information of the AI model or a model ID of the AI model.

In this embodiment, the model identity of the AI model can indicate, or include, or be associated with the first information. In a case that the environment or working status or operating parameter associated with the first information changes, the terminal may automatically activate, or switch, or update to obtain the target AI model, thereby improving environment intelligence of the AI model and reducing the system signaling overhead.

Step 403: In a case that the terminal identifies the model identity of the target AI model, the terminal activates, or switches, or updates to obtain the target AI model, where the model identity of the target AI model indicates, or includes, or is associated with the identity information of the terminal.

In step 403, identifying, by the terminal, the model identity of the target AI model means that the terminal can correctly parse to obtain the model identity of the target AI model. For example, the terminal obtains the model identity of the target AI model, and then parses to obtain all information or implicit information of the model identity. Because the model identity of the target AI model indicates, or includes, or is associated with the identity information of the terminal, the terminal may understand that the target AI model is an AI model that can be used by the terminal. In this case, the terminal may activate, or switch, or update to obtain the target AI model.

In an implementation of this application, the identity information includes one or more of the following: a terminal identity; and a terminal device provider identity.

In this embodiment, the model identity of the AI model can indicate, or include, or be associated with the first information. In a case that the terminal identifies the model identity of the target AI model, the terminal may automatically activate, or switch, or update the target AI model, thereby improving environment intelligence of the AI model and reducing the system signaling overhead.

In an implementation of this application, the terminal obtains at least one piece of AI model information, including: the terminal receives at least one piece of AI model information sent by a first node, where the first node includes at least one of the following: (1) a core network device, for example, a network data analysis function (NWDAF), a location management function (LMF), or a neural network processing node; (2) an access network device, for example, a base station or a newly defined neural network processing node; and (3) a third party device, for example, an OTT (over the top) server.

For example, the first node sends or broadcasts the at least one piece of AI model information to the terminal.

In another implementation of this application, the terminal obtains at least one piece of AI model information, including: the terminal obtains the at least one piece of AI model information locally, that is, the terminal may carry the at least one piece of AI model information.

In an implementation of this application, the updating, by the terminal, to obtain the target AI model, where the model identity of the target AI model indicates, or includes, or is associated with first information related to the new environment or working status or operating parameter, includes:
in a case that an AI model update condition is satisfied, the terminal updates the first information indicated by, or included in, or associated with the model identity of the target AI model to the first information related to a new environment or working status or operating parameter; or, the terminal updates to obtain the target AI model through the first AI model, where the target AI model is a new AI model, and a model identity of the target AI model indicates, or includes, or is associated with the first information related to the new environment or working status or operating parameter. The first AI model may be understood as an AI model currently used by the terminal. That is, the AI model currently used by the terminal is updated to the target AI model. In an AI model update process, the first AI model may also be referred to as a source AI model.

In an implementation of this application, the first information indicated by, or included in, or associated with the model identity of the first model is unchanged.

That is, the terminal may update to obtain the target AI model in two modes:

Mode 1: The terminal updates parameters of the currently used AI model to obtain the target AI model, the target AI model and the currently used AI model are considered as the same AI model, and the first information indicated by, or included in, or associated with the model identity of the target AI model is updated to first information related to the new environment or working status or operating parameter (or described as first information in a current case).

Mode 2: The terminal updates the parameters of the currently used AI model to obtain the target AI model. The target AI model is a new AI model, and the model identity of the target AI model indicates, or includes, or is associated with the first information (or described as the first information in a current case) related to the new environment or working status or operating parameter. Optionally, the first information indicated by, or included in, or associated with the model identity of the AI model before the update is unchanged.

In an implementation of this application, the cell identity includes at least one of the following: a physical cell identity; a serving cell identity; a transmission and receiving point (TRP) identity; a tracking area identity; a cell group identity; and a reference signal identity associated with a cell.

In an implementation of this application, in a case that the environment or working status or operating parameter associated with the first information changes, activating or switching, by the terminal, the target AI model includes at least one of the following:

(1) The first information is a cell identity, and in a case that the terminal moves to a new cell, the terminal activates or switches the target AI model, where the model identity of the target AI model indicates, or includes, or is associated with a cell identity of the new cell.

(2) The first information is an identity of a network operator, and in a case that the terminal moves to a service area of a new network operator, the terminal activates or switches the target AI model, where the model identity of the target AI model indicates, or includes, or is associated with the new network operator identity.

(3) The first information is a network device provider identity, and in a case that the terminal moves to a service area of a new network device provider, the terminal activates or switches the target AI model, where the model identity of the target AI model indicates, or includes, or is associated with the new network device provider identity.

(4) The first information is a network device provider identity, and in a case that the terminal moves to a service area of a new network device provider, the terminal activates or switches the target AI model, where the model identity of the target AI model indicates, or includes, or is associated with the new network device provider identity.

(5) The first information is location information, and in a case that the terminal moves to a new location area, the terminal activates or switches the target AI model, where the model identity of the target AI model indicates, or includes, or is associated with the location information of the new location area.

(6) The first information is channel quality information, and in a case that the channel quality of the terminal is within a new channel quality interval, the terminal activates or switches the target AI model, where the model identity of the target AI model indicates, or includes, or is associated with channel quality information of the new channel quality interval.

The channel quality information includes, but is not limited to, at least one of the following: signal to noise ratio (SNR), reference signal receiving power (PSRP), signal to interference plus noise ratio (SINR), and reference signal receiving quality (RSRQ).

(7) The first information is BWP information, and in a case that the terminal switches to a new BWP, the terminal activates or switches the target AI model, where the model identity of the target AI model indicates, or includes, or is associated with BWP information of the new BWP.

(8) The first information is frequency information, and in a case that the terminal switches to a new operating frequency, the terminal activates or switches the target AI model, where the model identity of the target AI model indicates, or includes, or is associated with the frequency information of the new operating frequency.

(9) The first information is PLMN information, and in a case that the terminal moves to a new PLMN, the terminal activates or switches the target AI model, where the model identity of the target AI model indicates, or includes, or is associated with PLMN information of the new PLMN.

(10) The first information is timestamp information, and in a case that the terminal works in a new time interval, the terminal activates or switches the target AI model, where the model identity of the target AI model indicates, or includes, or is associated with the timestamp information of the new time interval.

In an implementation of this application, the in a case that the environment or working status or operating parameter associated with the first information changes, activating, or switching, or updating, by the terminal, to obtain the target AI model, where the model identity of the target AI model indicates, or includes, or is associated with first information related to a new environment or working status or operating parameter, includes:

in a case that the AI model activation or switching condition is satisfied, and the first information indicated by, or included in, or associated with the model identity of the current AI model of the terminal does not match the first information related to the current environment or working status or operating parameter, the terminal activates or switches the target AI model, where the first information indicated by, or included in, or associated with the model identity of the target AI model most matches (or is closest to) the first information related to the current environment or working status or operating parameter.

For example, when the first information is the cell identity, the cell identity indicated by, or included in, or associated with the model identity of the current AI model of the terminal does not match the cell identity of the current cell, an AI model in which corresponding cell identity relatively most matches (or is closest to) the cell identity of the current cell in the AI model is used as the target AI model, and the target AI model is activated or switched.

For another example, the first information is the identity of the network operator. In a case that the identity of the network operator indicated by, included in, or associated with the model identity of the current AI model of the terminal does not match the identity of the current network operator, an AI model in which corresponding identity of the network operator relatively most matches (or is closest to) the identity of the current network operator in the AI model is used as the target AI model, and the target AI model is activated or switched.

For another example, the first information is the network device provider identity. In a case that the network device provider identity indicated by, included in, or associated with the model identity of the current AI model of the terminal does not match the identity of the current network device, an AI model in which corresponding network device provider identity relatively most matches (or is closest to) the identity of the current network device provider in the AI model is used as the target AI model, and the target AI model is activated or switched.

For another example, the first information is the channel quality information. In a case that the channel quality information indicated by, or included in, or associated with the model identity of the current AI model of the terminal does not match the channel quality information of the current channel quality, an AI model in which corresponding channel quality information relatively most matches (or is closest to) the channel information of the current channel quality in the AI models is used as the target AI model, and the target AI model is activated or switched.

In an implementation of this application, the AI model update condition or the AI model activating or switching condition includes at least one of the following:

(1) a first condition, the first condition including that performance of the current AI model does not satisfy a requirement of the terminal;

(2) a second condition, the second condition including that the terminal obtains a first indication, and the first indication is used for indicating to deactivate the current AI model, for example, the terminal, a network side, or another node indicates the current AI model to deactivate, where the current AI model refers to an AI model currently used by the terminal; and

(3) a third condition, the third condition including that the terminal obtains a second indication, and the second indication is used for indicating the new AI model. For example, the terminal, the network side, or another node indicates the new AI model.

In an implementation of this application, the AI model includes a first function module, the first function module being configured to perform at least one of the following:
(1) signal processing, including, but not limited to, at least one of the following: signal detection, filtering, equalization, and the like, where the signal includes, but is not limited to, at least one of the following: a demodulation reference signal (DMRS), a sounding reference signal (SRS), a synchronization signal and PBCH block (SSB), a tracking reference signal (TRS), a phase-tracking reference signal (PTRS), a channel-state-information reference signal (CSI-RS), and the like;
(2) channel transmission, channel receiving, channel demodulation, or channel sending, where the channel includes, but is not limited to, at least one of the following: a physical downlink control channel (PDCCH), a physical downlink shared channel (PDSCH), a physical uplink control channel (PUCCH), a physical uplink shared channel (PUSCH), physical random access channel (PRACH), and a physical broadcast channel (PBCH);
(3) channel state information processing,
for example, a channel state information feedback, including, but not limited to, at least one of the following: channel related information, channel matrix related information, channel feature information, channel matrix feature information, a precoding matrix indicator (PMI), a Rank indicator (RI), a CSI-RS Resource Indicator (CRI), a Channel quality indicator (CQI), a Layer Indicator (LI), and the like;
for another example, reciprocity between an uplink part and a downlink part of frequency division multiplex (FDD), where for an FDD system, according to partial reciprocity, a base station obtains angle information and delay information according to an uplink channel, and may notify the terminal of the angle information and the delay information by using a CSI-RS precoding method or a direct indication method, and the terminal reports the angle information and the delay information according to an indication of the base station or selects and reports the angle information within an indication range of the base station, thereby reducing a calculation amount of the terminal and the overhead of reporting CSI;
(4) beam management, including, but not limited to, at least one of the following: beam measurement, beam reporting, beam prediction, beam failure detection, beam failure recovery, and a new beam indication in beam failure recovery;
(5) channel prediction, including, but not limited to, at least one of the following: channel state information prediction and beam prediction;
(6) interference suppression, including, but not limited to, at least one of the following: intra-cell interference, inter-cell interference, out-of-band interference, cross-tone interference, and the like;
(7) positioning, for example, estimating a specific location (including a horizontal location and/or a vertical location) or a possible future trajectory of the terminal by using a reference signal (for example, an SRS), or estimating information assisting in location estimation or trajectory estimation of the terminal;
(8) high-level service and/or high-level parameter prediction or management, including, but not limited to, at least one of the following: throughput, a required packet size, a service requirement, a moving speed, noise information, and the like; and
(9) control signaling parsing, including, but not limited to, at least one of the following: signaling related to power control, and signaling related to beam management.

In this embodiment of this application, in a case that the environment or working status or operating parameter associated with the first information changes, or in a case that the terminal identifies the model identity of the target AI model, the terminal may automatically activate, or switch, or update the target AI model, thereby improving the environment intelligence of the AI model and reducing the system signaling overhead.

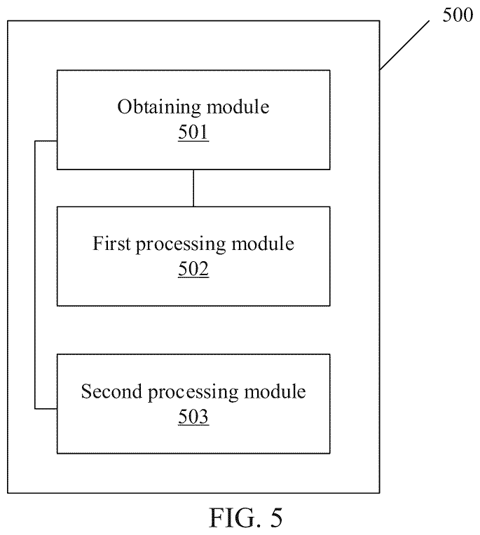

Referring to FIG. 5, an embodiment of this application provides an AI model processing apparatus applied to a terminal. The apparatus 500 includes: a first obtaining module 501, and a first processing module 502 or a second processing module 503.

The obtaining module 501 is configured to obtain at least one piece of AI model information, the AI model information carrying or being associated with a model identity of an AI model, where the model identity indicates, or includes, or is associated with first information, and the first information is used for representing information related to an environment in which a terminal is located or a working status of the terminal or an operating parameter of the terminal.

The first processing module 502 is configured to: in a case that the environment or working status or operating parameter associated with the first information changes, activate, or switch, or update a target AI model, where the model identity of the target AI model indicates, or includes, or is associated with first information related to a new environment or working status or operating parameter.

The second processing module 503 is configured to: in a case that the terminal identifies the model identity of the target AI model, activate, or switch, or update the target AI model, where the model identity of the target AI model indicates, or includes, or is associated with the identity information of the terminal.

In an implementation of this application, the obtaining module 501 is further configured to: receive at least one piece of AI model information sent by a first node, where the first node includes: at least one of a core network device, an access network device, or a third party device; or, obtain the at least one piece of AI model information locally.

In an implementation of this application, the first processing module 502 is further configured to:
in a case that the AI model update condition is satisfied, update the first information indicated by, or included in, or associated with the model identity of the target AI model to the first information related to the new environment or working status or operating parameter; or, update, by the terminal, to obtain the target AI model through the first AI model, the target AI model being a new AI model, where the model identity of the target AI model indicates, or includes, or is associated with the first information related to the new environment or working status or operating parameter.

In an implementation of this application, the first information indicated by, or included in, or associated with the model identity of the first model is unchanged.

In an implementation of this application, the first information includes one or more of the following: a cell identity; an identity of a network operator; a network device provider identity; location information; channel quality information; BWP information; frequency information; PLMN information; and timestamp information.

In an implementation of this application, the cell identity includes at least one of the following: a physical cell identity; a serving cell identity; a TRP identity; a tracking area identity; a cell group identity; and a reference signal identity associated with a cell.

In an implementation of this application, the first processing module 502 is further configured to perform at least one of the following:
the first information being the cell identity, and in a case that the terminal moves to a new cell, activate or switch the target AI model, where the model identity of the target AI model indicates, or includes, or is associated with a cell identity of the new cell;
the first information being the identity of the network operator, and in a case that the terminal moves to a service area of a new network operator, activate or switch the target AI model, where the model identity of the target AI model indicates, or includes, or is associated with the new network operator identity;
the first information being a network device provider identity, and in a case that the terminal moves to a service area of a new network device provider, activate or switch the target AI model, where the model identity of the target AI model indicates, or includes, or is associated with the new network device provider identity;
the first information being location information, and in a case that the terminal moves to a new location area, activate or switch the target AI model, where the model identity of the target AI model indicates, or includes, or is associated with the location information of the new location area;
the first information being channel quality information, and in a case that the channel quality of the terminal is within a new channel quality interval, activate or switch the target AI model, where the model identity of the target AI model indicates, or includes, or is associated with channel quality information of the new channel quality interval;
the first information being BWP information, and in a case that the terminal switches to a new BWP, activate or switch the target AI model, where the model identity of the target AI model indicates, or includes, or is associated with BWP information of the new BWP;
the first information is frequency information, and in a case that the terminal is switched to a new operating frequency, activate or switch the target AI model, where a model identity of the target AI model indicates, or includes, or is associated with the frequency information of the new operating frequency;
the first information being PLMN information, and in a case that the terminal moves to a new PLMN, activate or switch the target AI model, where the model identity of the target AI model indicates, or includes, or is associated with PLMN information of the new PLMN; and
the first information being timestamp information, and in a case that the terminal works in a new time interval, activate or switch the target AI model, where the model identity of the target AI model indicates, or includes, or is associated with the timestamp information of the new time interval.

In an implementation of this application, the first processing module 502 is further configured to perform the following: in a case that the AI model activation or switching condition is satisfied, and the first information indicated by, or included in, or associated with the model identity of the current AI model of the terminal does not match the first information related to the current environment or working status or operating parameter, the terminal activates or switches the target AI model, where the first information indicated by, or included in, or associated with the model identity of the target AI model most matches (or is closest to) the first information related to the current environment or working status or operating parameter.

In an implementation of this application, the AI model update condition or the AI model activating or switching condition includes at least one of the following:
a first condition, the first condition including that performance of the current AI model does not satisfy a requirement of the terminal;
a second condition, the second condition including that the terminal obtains a first indication, the first indication being used for indicating to deactivate the current AI model; and
a third condition, the third condition including that the terminal obtains a second indication, the second indication being used for indicating a new AI model.

In an implementation of this application, the identity information includes one or more of the following: a terminal identity; and a terminal device provider identity.

In an implementation of this application, the AI model includes a first function module, the first function module being configured to perform at least one of the following:
signal processing;
channel transmission, channel receiving, channel demodulation, or channel sending;
channel state information processing;
beam management;
channel prediction;
interference suppression;
positioning;
high-level service and/or high-level parameter prediction or management; and
control signaling parsing.

The apparatus provided in this embodiment of this application can implement all processes implemented by the method embodiments in FIG. 4 and the same technical effects are achieved. Details are not described herein again to avoid repetition.

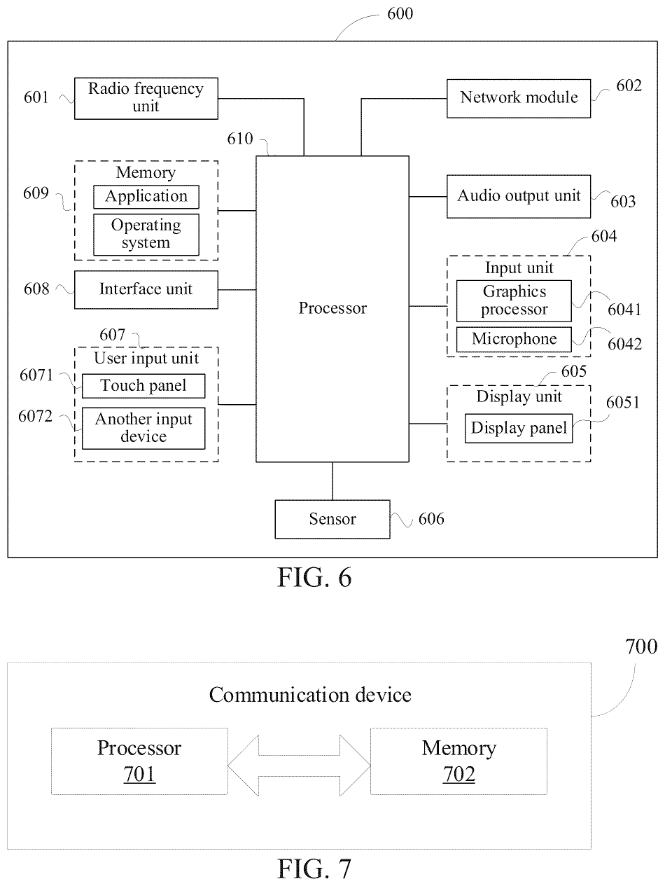

FIG. 6 is a schematic structural diagram of a hardware structure of a terminal according to an embodiment of this application. The terminal 600 includes but is not limited to: at least a part of components such as a radio frequency unit 601, a network module 602, an audio output unit 603, an input unit 604, a sensor 605, a display unit 606, a user input unit 607, an interface unit 608, a memory 609 and a processor 610.

A person skilled in the art may understand that the terminal 600 may further include a power supply (such as a battery) that supplies power to various components. The power supply may be logically connected to the processor 610 through a power management system, thereby implementing functions of charging management, discharging management, and power consumption management through the power management system. The terminal structure shown in FIG. 6 does not constitute any limitation on the terminal, and the terminal may include more or fewer components than shown, or combine some components, or have different component arrangements. Details are not described herein again.

It should be understood that in this embodiment of this application, the input unit 604 may include a graphics processing unit (GPU) 6041 and a microphone 6042, and the graphics processing unit 6041 processes image data of a static picture or video obtained by an image capturing apparatus (such as a camera) in a video capture mode or an image capture mode. The display unit 606 may include a display panel 6061. The display panel 6061 may be configured by using a liquid crystal display, an organic light-emitting diode, or the like. The user input unit 607 includes at least one of a touch panel 6071 and another input device 6072. The touch panel 6071 is also referred to as a touchscreen. The touch panel 6071 may include two parts: a touch detection apparatus and a touch controller. The another input device 6072 may include, but is not limited to, a physical keyboard, a functional key (such as a volume control key or a switch key), a track ball, a mouse, and a joystick. Details are not described herein again.

In this embodiment of this application, after receiving downlink data from the network side device, the radio frequency unit 601 can transmit the downlink data to the processor 610 for processing. In addition, the radio frequency unit 601 may send uplink data to the network side device. Generally, the radio frequency unit 601 includes, but is not limited to, an antenna, an amplifier, a transceiver, a coupler, a low noise amplifier, a duplexer, and the like.

The memory 609 may be configured to store a software program or instruction and various data. The memory 609 may mainly include a first storage area for storing a program or instruction, and a second storage area for storing data, where the first storage area may store an operating system, at least one application program or instruction required for a function (such as a sound playback function and an image playback function), and the like Besides, the memory 609 may be a volatile memory or a non-volatile memory, or the memory 609 may include both a volatile memory and a non-volatile memory. The non-transitory memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct Rambus random access memory (Direct Rambus RAM, DRRAM). The memory 609 in this embodiment of this application includes but is not limited to these memories and any other suitable types of memories.

The processor 610 may include one or more processing units. Optionally, the processor 610 integrates an application processor and a modem processor, where the application processor mainly processes operations relating to an operating system, a user interface, an application program, and the like, and the modem processor, such as a baseband processor, mainly processes a wireless communication signal. It may be understood that the foregoing modem processor may not be integrated into the processor 610.

The terminal provided in the embodiment of this application can implement the various processes implemented in the method embodiment in FIG. 4 and achieve the same technical effect. Details are not described herein again to avoid repetition.

Optionally, as shown in FIG. 7, the embodiments of this application further provide a communication device 700, including a processor 701 and a memory 702. The memory 702 stores a program or instruction runnable on the processor 701. For example, when the communication device 700 is a terminal, the program or instruction, when run by the processor 701, implements steps of the above method embodiment in FIG. 4 and can achieve the same technical effects. Details are not described herein again to avoid repetition.

An embodiment of this application further provides a readable storage medium. A program or instruction is stored on the readable storage medium. The program or instruction, when executed by the processor, implements the various processes of the method in FIG. 4 and the above embodiments, and can achieve the same technical effect. Details are not described herein again to avoid repetition.

The processor may be a processor of the terminal in foregoing embodiments. The readable storage medium includes a computer-readable storage medium, such as a computer read-only memory (ROM), a random access memory (RAM), a magnetic disc, an optical disc, or the like.

An embodiment of this application further provides a chip, where the chip includes a processor and a communication interface, the communication interface is coupled to the processor, and the processor is configured to run a program or instruction, to implement the processes in FIG. 4 and the method embodiments, and can achieve the same technical effects. Details are not described herein again to avoid repetition.

It should be understood that the chip mentioned in this embodiment of this application may also be referred to as a system on a chip, a system chip, a chip system, a system-on-chip, or the like.

An embodiment of this application further provides a computer program/program product. The computer program/program product is stored on a storage medium. The computer program/program product, when executed by at least one processor, implements the various processes of the method embodiment in FIG. 4, and can achieve the same technical effect. Details are not described herein again to avoid repetition.

An embodiment of this application further provides a communication system. The communication system includes a terminal and a network side device. The terminal is configured to execute the various processes in FIG. 4 and the above method embodiments, and can achieve the same technical effect. Details are not described herein again to avoid repetition.

It should be noted that the terms “include”, “comprise”, or any other variation thereof herein are intended to cover a non-exclusive inclusion, so that a process, a method, an object, or an apparatus including a series of elements not only includes those elements but also includes other elements which are not clearly listed or further includes intrinsic elements of the process, the method, the object, or the apparatus. Without more limitations, an element defined by a sentence “including one” does not exclude a case that there are still other same elements in the process, method, article, or apparatus that includes the element. In addition, it should be pointed out that the range of the method and apparatus in the implementation of this application is not limited to execution of functions in order shown or discussed, and can further include execution of functions involved in a substantially simultaneous manner or in reverse order. For example, the described method can be executed in order different from that described, and various steps can be added, omitted, or combined. Moreover, features described with reference to some examples may be combined in other examples.

According to the descriptions in the foregoing implementations, a person skilled in the art may clearly learn that the method according to the foregoing embodiment may be implemented by relying on software and a commodity hardware platform or by using hardware. Based on such an understanding, the technical solutions of this application essentially or the part contributing to the prior art may be implemented in a form of a software product. The computer software product is stored in a storage medium (such as a ROM/RAM, a magnetic disk, or an optical disc) and includes several indications for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to above specific implementations. The above specific implementations are merely illustrative rather than restrictive. Inspired by this application, a person of ordinary skill in the art may still make multiple forms without departing from the essence of this application and the scope of protection of the claims, which all fall within the protection of this application.

1. An artificial intelligence (AI) model processing method, comprising:
obtaining, by a terminal, at least one piece of AI model information, the AI model information carrying or being associated with a model identity of an AI model, wherein the model identity indicates, or comprises, or is associated with first information, and the first information is used for representing information related to an environment or working status or operating parameter of the terminal;
in a case that the environment or working status or operating parameter associated with the first information changes, activating, or switching, or updating, by the terminal, to obtain a target AI model, wherein a model identity of the target AI model indicates, or comprises, or is associated with first information related to a new environment or working status or operating parameter;
or, in a case that the terminal identifies the model identity of the target AI model, activating, or switching, or updating, by the terminal, to obtain the target AI model, wherein the model identity of the target AI model indicates, or comprises, or is associated with the identity information of the terminal.

2. The method according to claim 1, wherein the obtaining, by a terminal, at least one piece of AI model information comprises:
receiving, by the terminal, at least one piece of AI model information sent by a first node, wherein the first node comprises: at least one of a core network device, an access network device, or a third party device;
or,
obtaining, by the terminal, the at least one piece of AI model information locally.

3. The method according to claim 1, wherein the updating, by the terminal, to obtain a target AI model, wherein a model identity of the target AI model indicates, or comprises, or is associated with first information related to a new environment or working status or operating parameter, comprises:
in a case that an AI model update condition is satisfied, updating, by the terminal, the first information indicated by, or comprised in, or associated with the model identity of the target AI model to the first information related to a new environment or working status or operating parameter; or, updating, by the terminal, to obtain the target AI model through the first AI model, the target AI model being a new AI model, where the model identity of the target AI model indicates, or comprises, or is associated with the first information related to the new environment or working status or operating parameter.

4. The method according to claim 3, wherein the first information indicated by, or comprised in, or associated with the model identity of the first model is unchanged.

5. The method according to claim 1, wherein the first information comprises one or more of the following: a cell identity; an identity of a network operator; a network device provider identity; location information; channel quality information; bandwidth part (BWP) information; frequency information; public land mobile network (PLMN) information; or timestamp information.

6. The method according to claim 5, wherein the cell identity comprises at least one of the following: a physical cell identity; a serving cell identity; a transmission and receiving point (TRP) identity; a tracking area identity; a cell group identity; or a reference signal identity associated with a cell.

7. The method according to claim 5, wherein in a case that the environment or working status or operating parameter associated with the first information changes, activating or switching, by the terminal, the target AI model comprises at least one of the following:
the first information being the cell identity, and in a case that the terminal moves to a new cell, activating or switching, by the terminal, the target AI model, wherein the model identity of the target AI model indicates, or comprises, or is associated with a cell identity of the new cell;
the first information being the identity of the network operator, and in a case that the terminal moves to a service area of a new network operator, activating or switching, by the terminal, the target AI model, wherein the model identity of the target AI model indicates, or comprises, or is associated with the new network operator identity;
the first information being a network device provider identity, and in a case that the terminal moves to a service area of a new network device provider, activating or switching, by the terminal, the target AI model, wherein the model identity of the target AI model indicates, or comprises, or is associated with the new network device provider identity;
the first information being location information, and in a case that the terminal moves to a new location area, activating or switching, by the terminal, the target AI model, wherein the model identity of the target AI model indicates, or comprises, or is associated with the location information of the new location area;
the first information being channel quality information, and in a case that the channel quality of the terminal is within a new channel quality interval, activating or switching, by the terminal, the target AI model, wherein the model identity of the target AI model indicates, or comprises, or is associated with channel quality information of the new channel quality interval;
the first information being BWP information, and in a case that the terminal switches to a new BWP, activating or switching, by the terminal, the target AI model, wherein the model identity of the target AI model indicates, or comprises, or is associated with BWP information of the new BWP;
the first information being frequency information, and in a case that the terminal switches to a new operating frequency, activating or switching, by the terminal, the target AI model, wherein the model identity of the target AI model indicates, or comprises, or is associated with the frequency information of the new operating frequency;
the first information being PLMN information, and in a case that the terminal moves to a new PLMN, activating or switching, by the terminal, the target AI model, wherein the model identity of the target AI model indicates, or comprises, or is associated with PLMN information of the new PLMN; or
the first information being timestamp information, and in a case that the terminal works in a new time interval, activating or switching, by the terminal, the target AI model, wherein the model identity of the target AI model indicates, or comprises, or is associated with the timestamp information of the new time interval.

8. The method according to claim 1, wherein the in a case that the environment or working status or operating parameter associated with the first information changes, activating, or switching, or updating, by the terminal, the target AI model, wherein a model identity of the target AI model indicates, or comprises, or is associated with first information related to a new environment or working status or operating parameter, comprises:
in a case that the AI model activating or switching condition is satisfied, and the first information indicated by, or comprised in, or associated with the model identity of the current AI model of the terminal does not match the first information related to the current environment or working status or operating parameter, activating or switching, by the terminal, the target AI model, wherein the first information indicated by, or comprised in, or associated with the model identity of the target AI model most matches the first information related to the current environment or working status or operating parameter.

9. The method according to claim 3, wherein the AI model update condition or the AI model activating or switching condition comprises at least one of the following:
a first condition, the first condition comprising that performance of the current AI model does not satisfy a requirement of the terminal;
a second condition, the second condition comprising that the terminal obtains a first indication, the first indication being used for indicating to deactivate the current AI model; or
a third condition, the third condition comprising that the terminal obtains a second indication, the second indication being used for indicating a new AI model.

10. The method according to claim 1, wherein the identity information of the terminal comprises one or more of the following: a terminal identity; or a terminal device provider identity.

11. The method according to claim 1, wherein the AI model comprises a first function module, the first function module being configured to perform at least one of the following:
signal processing;
channel transmission, channel receiving, channel demodulation, or channel sending;
channel state information processing;
beam management;
channel prediction;
interference suppression;
positioning;
high-level service and/or high-level parameter prediction or management; or
control signaling parsing.

12. A communication device, comprising a processor, a memory, and a program or an instruction stored in the memory and runnable on the processor, wherein the program or the instruction, when executed by the processor, causes the communication device to perform:
obtaining at least one piece of AI model information, the AI model information carrying or being associated with a model identity of an AI model, wherein the model identity indicates, or comprises, or is associated with first information, and the first information is used for representing information related to an environment or working status or operating parameter of a terminal;
in a case that the environment or working status or operating parameter associated with the first information changes, activating, or switching, or updating to obtain a target AI model, wherein a model identity of the target AI model indicates, or comprises, or is associated with first information related to a new environment or working status or operating parameter;
or, in a case that the terminal identifies the model identity of the target AI model, activating, or switching, or updating to obtain the target AI model, wherein the model identity of the target AI model indicates, or comprises, or is associated with the identity information of the terminal.

13. The communication device according to claim 12, wherein when obtaining at least one piece of AI model information, the program or the instruction, when executed by the processor, causes the communication device to perform:
receiving at least one piece of AI model information sent by a first node, wherein the first node comprises: at least one of a core network device, an access network device, or a third party device;
or,
obtaining the at least one piece of AI model information locally.

14. The communication device according to claim 12, wherein when updating to obtain a target AI model, wherein a model identity of the target AI model indicates, or comprises, or is associated with first information related to a new environment or working status or operating parameter, the program or the instruction, when executed by the processor, causes the communication device to perform:
in a case that an AI model update condition is satisfied, updating the first information indicated by, or comprised in, or associated with the model identity of the target AI model to the first information related to a new environment or working status or operating parameter; or, updating to obtain the target AI model through the first AI model, the target AI model being a new AI model, where the model identity of the target AI model indicates, or comprises, or is associated with the first information related to the new environment or working status or operating parameter.

15. The communication device according to claim 14, wherein the first information indicated by, or comprised in, or associated with the model identity of the first model is unchanged.

16. The communication device according to claim 12, wherein the first information comprises one or more of the following: a cell identity; an identity of a network operator; a network device provider identity; location information; channel quality information; bandwidth part (BWP) information; frequency information; public land mobile network (PLMN) information; or timestamp information.

17. The communication device according to claim 16, wherein the cell identity comprises at least one of the following: a physical cell identity; a serving cell identity; a transmission and receiving point (TRP) identity; a tracking area identity; a cell group identity; or a reference signal identity associated with a cell.

18. The communication device according to claim 16, wherein when in a case that the environment or working status or operating parameter associated with the first information changes, activating or switching the target AI model, the program or the instruction, when executed by the processor, causes the communication device to perform at least one of the following:
the first information being the cell identity, and in a case that the terminal moves to a new cell, activating or switching the target AI model, wherein the model identity of the target AI model indicates, or comprises, or is associated with a cell identity of the new cell;
the first information being the identity of the network operator, and in a case that the terminal moves to a service area of a new network operator, activating or switching the target AI model, wherein the model identity of the target AI model indicates, or comprises, or is associated with the new network operator identity;
the first information being a network device provider identity, and in a case that the terminal moves to a service area of a new network device provider, activating or switching the target AI model, wherein the model identity of the target AI model indicates, or comprises, or is associated with the new network device provider identity;
the first information being location information, and in a case that the terminal moves to a new location area, activating or switching the target AI model, wherein the model identity of the target AI model indicates, or comprises, or is associated with the location information of the new location area;
the first information being channel quality information, and in a case that the channel quality of the terminal is within a new channel quality interval, activating or switching the target AI model, wherein the model identity of the target AI model indicates, or comprises, or is associated with channel quality information of the new channel quality interval;
the first information being BWP information, and in a case that the terminal switches to a new BWP, activating or switching the target AI model, wherein the model identity of the target AI model indicates, or comprises, or is associated with BWP information of the new BWP;
the first information being frequency information, and in a case that the terminal switches to a new operating frequency, activating or switching the target AI model, wherein the model identity of the target AI model indicates, or comprises, or is associated with the frequency information of the new operating frequency;
the first information being PLMN information, and in a case that the terminal moves to a new PLMN, activating or switching the target AI model, wherein the model identity of the target AI model indicates, or comprises, or is associated with PLMN information of the new PLMN; or
the first information being timestamp information, and in a case that the terminal works in a new time interval, activating or switching the target AI model, wherein the model identity of the target AI model indicates, or comprises, or is associated with the timestamp information of the new time interval.

19. A non-transitory readable storage medium, having a program or an instruction stored thereon, wherein the program or the instruction, when executed by a processor of a terminal, causes the processor of the terminal to perform:
obtaining at least one piece of AI model information, the AI model information carrying or being associated with a model identity of an AI model, wherein the model identity indicates, or comprises, or is associated with first information, and the first information is used for representing information related to an environment or working status or operating parameter of the terminal;
in a case that the environment or working status or operating parameter associated with the first information changes, activating, or switching, or updating to obtain a target AI model, wherein a model identity of the target AI model indicates, or comprises, or is associated with first information related to a new environment or working status or operating parameter;
or, in a case that the terminal identifies the model identity of the target AI model, activating, or switching, or updating to obtain the target AI model, wherein the model identity of the target AI model indicates, or comprises, or is associated with the identity information of the terminal.

20. A chip, comprising a processor and a communication interface, wherein the communication interface is coupled to the processor, and the processor is configured to run a program or instruction to implement steps of the method according to claim 1.
